(19) United States
(12) Patent Application Publication
(10) Pub. No.: US 2025/0237202 A1
(43) Pub. Date: Jul. 24, 2025

(54) POWER TRANSMISSION SYSTEM AND TURBINE FRACTURING DEVICE HAVING SAME

(71) Applicant: YANTAI JEREH PETROLEUM EQUIPMENT & TECHNOLOGIES CO., LTD., Yantai (CN)

(72) Inventors: Rikui ZHANG, Yantai (CN); Bo YU, Yantai (CN); Junlong DU, Yantai (CN); Zhuqing MAO, Yantai (CN); Wenping CUI, Yantai (CN); Peng ZHANG, Yantai (CN)

(73) Assignee: YANTAI JEREH PETROLEUM EQUIPMENT & TECHNOLOGIES CO., LTD., Yantai (CN)

(21) Appl. No.: 19/176,975

(22) Filed: Apr. 11, 2025

Related U.S. Application Data
(63) Continuation of application No. PCT/CN2024/113469, filed on Aug. 20, 2024.

(30) Foreign Application Priority Data
Nov. 30, 2023 (CN) 202311640280.8

(51) Int. Cl. F04B 17/05; E21B 43/26; F02C 7/25; F02C 7/36; F04B 49/20; F16H 37/06

(52) U.S. Cl. CPC F04B 17/05; E21B 43/2607; F02C 7/25; F02C 7/36; F04B 49/20; F16H 37/065

(57) ABSTRACT

This application provides a power transmission system and a turbine fracturing device having the same. An engine is drivingly connected to a deceleration mechanism. The deceleration mechanism includes a first power output portion and a second power output portion. A speed adjustment mechanism includes a first power input portion, a second power input portion, and a third power output portion. The first power input portion is selectively connected to or disconnected from the first power output portion, the second power input portion is selectively connected to or disconnected from the second power output portion, and the third power output portion is drivingly connected to a to-be-driven structure. The power transmission system has a first diverged state, a second diverged state, and a converged state. The technical solutions provided in this application address the inconvenience in adjusting an output speed of a power transmission system in the related art.

### CROSS-REFERENCE TO RELATED APPLICATIONS

This application is a continuation of and claims the benefit of priority to PCT International Patent Application No. PCT/CN2024/113469, filed on Aug. 20, 2024, which is based on and claims the benefit of priority to Chinese Patent Application No. 202311640280.8, filed with the China National Intellectual Property Administration on Nov. 30, 2023, and entitled “POWER TRANSMISSION SYSTEM”, which is incorporated herein by reference in its entirety.

### TECHNICAL FIELD

This application relates to fracturing plunger pump driving technologies, and specifically, to a power transmission system and a turbine fracturing device having the same.

### BACKGROUND

With the development of fracturing equipment technologies, fracturing devices with a turbine engine as a power source have emerged. The turbine engine has many advantages compared with a conventional diesel engine. For example, the turbine engine has a large single-unit power density, may use natural gas as a fuel by 100% to reduce fuel costs, and has more environmentally friendly engine emissions.

However, a power transmission system with a turbine engine in the related art has an undiversified speed adjustment manner, and its speed adjustment performance is often limited by features, such as a shape, a size, and a weight, of the power transmission system. Therefore, using the power transmission system in the related art leads to inconvenience in adjusting an output speed of the power transmission system according to a working requirement of a to-be-driven structure.

### SUMMARY

An objective of this application is to provide a power transmission system and a turbine fracturing device having the same, which can solve a problem of inconvenience in adjusting an output speed of a power transmission system in the related art.

To achieve the foregoing objective, this application provides a power transmission system including:
an engine;
a deceleration mechanism, including a first power output portion and a second power output portion, where the engine is drivingly connected to the deceleration mechanism; and
a speed adjustment mechanism, including a first power input portion, a second power input portion, and a third power output portion, where the first power input portion is selectively connected to or disconnected from the first power output portion, the second power input portion is selectively connected to or disconnected from the second power output portion, and the third power output portion is drivingly connected to a to-be-driven structure, where
the power transmission system has a first diverged state, a second diverged state, and a converged state; when the power transmission system is in the first diverged state, the first power input portion is connected to the first power output portion, and the second power input portion is disconnected from the second power output portion; when the power transmission system is in the second diverged state, the first power input portion is disconnected from the first power output portion, and the second power input portion is connected to the second power output portion; and when the power transmission system is in the converged state, the first power input portion is connected to the first power output portion, and the second power input portion is connected to the second power output portion.

In an embodiment, the speed adjustment mechanism includes a gear speed adjustment structure; and/or the deceleration mechanism includes a gear deceleration structure.

In an embodiment, the speed adjustment mechanism includes:
a first planetary gear structure, including a first sun gear, a plurality of first planet gears, and a first ring gear, which are sequentially meshed, and further comprising a first planet gear carrier rotatably arranged, wherein the plurality of first planet gears is all connected to the first planet gear carrier;
a speed adjustment gear, wherein the speed adjustment gear is meshed with an outer periphery of the first ring gear;
a first power input shaft, wherein the first power input shaft is arranged on the speed adjustment gear and forms the first power input portion;
a second power input shaft, wherein the second power input shaft is arranged on the first sun gear and forms the second power input portion; and
a third power output shaft, wherein the third power output shaft is arranged on the first planet gear carrier and forms the third power output portion.

In an embodiment, the power transmission system further includes:
a speed change mechanism, and
a power disconnection mechanism, where the power disconnection mechanism has a power-connected state and a power-disconnected state; and
the speed change mechanism is arranged between the first power input portion and the first power output portion, and the power disconnection mechanism is arranged between the second power input portion and the second power output portion; or the speed change mechanism is arranged between the second power input portion and the second power output portion, and the power disconnection mechanism is arranged between the first power input portion and the first power output portion.

In an embodiment, the power disconnection mechanism includes a clutch and a brake, and when the power disconnection mechanism is in the power-connected state, the clutch is engaged with the first power output portion or the second power output portion, and the brake releases braking; and when the power disconnection mechanism is in the power-disconnected state, the clutch is disengaged from the first power output portion or the second power output portion, and the brake performs braking.

In an embodiment, the speed change mechanism is a multi-gear structure and has a multi-gear speed adjustment state and a neutral braking state; and when the speed change mechanism is in the multi-gear speed adjustment state, the speed change mechanism is configured to decelerate the first power output portion or the second power output portion.

In an embodiment, the deceleration mechanism includes:
a second planetary gear structure, including a second sun gear, a plurality of second planet gears, and a second ring gear, which are sequentially meshed, and further including a second planet gear carrier fixedly arranged, where the plurality of second planet gears is all connected to the second planet gear carrier;
a parallel-axis gear structure, including a first parallel-axis gear and a second parallel-axis gear that are meshed and fitted with each other,
a first power output shaft, wherein the second ring gear is connected to the first parallel-axis gear by the first power output shaft to drive the first parallel-axis gear to rotate, and the first power output shaft is arranged on the first parallel-axis gear and forms the first power output portion,
a second power output shaft, wherein the second power output shaft is arranged on the second parallel-axis gear and forms the second power output portion.

In an embodiment, the speed change mechanism is a variable-frequency motor.

In an embodiment, the to-be-driven structure includes:
a deceleration module, where the third power output portion is drivingly connected to a power input end of the deceleration module; and
a plunger pump, where a power output end of the deceleration module is drivingly connected to the plunger pump to drive the plunger pump to work.

In an embodiment, the engine is a single-shaft turbine engine, a double-shaft turbine engine, a triple-shaft turbine engine, a reciprocal engine, or an electric motor.

According to another aspect of this application, a turbine fracturing device includes:
the power transmission system provided above; and
a carrier, where the power transmission system is mounted on the carrier.

In an embodiment, the turbine fracturing device further includes:
a muffling compartment, arranged on the carrier, and including a muffling cavity, where
the engine of the power transmission system is arranged in the muffling cavity.

In an embodiment, the turbine fracturing device further includes:
an air inlet compartment body, arranged on the carrier, where an inlet of the air inlet compartment body is configured to admit air, and an outlet of the air inlet compartment body is in communication with an air inlet of the engine; and/or
a muffler, arranged on the carrier, where a muffler inlet of the muffler is in communication with an exhaust port of the engine, to muffle a gas discharged through the exhaust port of the engine; and/or
a fire-fighting system, where at least a part of the fire-fighting system is arranged in the muffling cavity.

In an embodiment, the turbine fracturing device further includes:
an auxiliary power system, arranged on the carrier, where the auxiliary power system includes at least one of a load component lubrication driving component, a lubricant cooling driving component, a ventilation driving component arranged in the muffling cavity, an air path system driving component, a control system driving component, or an air compressor, where the engine of the power transmission system drives the auxiliary power system to operate.

In an embodiment, the carrier is a semi-trailer structure.

In an embodiment, the engine of the power transmission system is a single-shaft turbine engine, a double-shaft turbine engine, a triple-shaft turbine engine, a reciprocal engine, or an electric motor.

According to this application, the first power input portion is selectively connected to or disconnected from the first power output portion, and the second power input portion is selectively connected to or disconnected from the second power output portion, so that the power transmission system can be switched to the first diverged state, the second diverged state, or the converged state, thereby facilitating performing corresponding state adjustment according to a specific working requirement of the to-be-driven structure, which improves flexibility of speed adjustment of the power transmission system, and facilitating adjusting the output speed of the power transmission system according to the working requirement of the to-be-driven structure.

### BRIEF DESCRIPTION OF THE DRAWINGS

Accompanying drawings of the specification that constitute a part of this application are used for providing further understanding about this application. Exemplary embodiments of this application and descriptions thereof are used for explaining this application, and do not constitute an inappropriate limitation on this application. In the accompanying drawings:

FIG. 1 is an example schematic diagram of a power transmission system according to Embodiment 1 of this application;

FIG. 2 is an example schematic diagram of a speed adjustment structure according to Embodiment 1 of this application;

FIG. 3 is an example schematic diagram of a power disconnection mechanism according to Embodiment 1 of this application;

FIG. 4 is an example schematic diagram of a deceleration mechanism according to Embodiment 1 of this application;

FIG. 5 is an example schematic diagram of a to-be-driven structure according to Embodiment 1 of this application;

FIG. 6 is an example schematic diagram of a power transmission system according to Embodiment 2 of this application;

FIG. 7 is an example schematic diagram of a power transmission system according to Embodiment 3 of this application;

FIG. 8 is an example schematic diagram of a power transmission system according to Embodiment 4 of this application; and

FIG. 9 is an example schematic diagram of a turbine fracturing device according to Embodiment 5 of the present application.

The foregoing accompanying drawings include the following reference numerals:
10: engine;
20. deceleration mechanism; 21. second planetary gear structure; 211. second sun gear; 212. second planet gear; 213. second ring gear; 214. second planet gear carrier; 22. parallel-axis gear structure; 221. first parallel-axis gear; 222. second parallel-axis gear; 23. first power output shaft; 24. second power output shaft;
30. speed adjustment mechanism; 31. first planetary gear structure; 32: speed adjustment gear; 311. first sun gear; 312. first planet gear; 313. first ring gear; 314. first planet gear carrier; 33. first power input shaft; 34. second power input shaft; 35. third power output shaft;
40. speed change mechanism;
50. power disconnection mechanism; 51. clutch; 52. brake;
60. to-be-driven structure; 61. deceleration module; 62. plunger pump;
70. carrier; 80. muffling compartment; 90. air inlet compartment body; 100: muffler; 110: fire-fighting system; 120: diffusion tube; 130. gearbox.

### DETAILED DESCRIPTION

It should be noted that embodiments in this application and features in the embodiments may be combined with one another if no conflict occurs. This application is described below in detail with reference to the accompanying drawings and the embodiments.

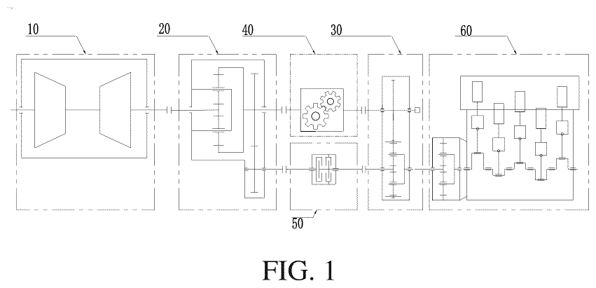

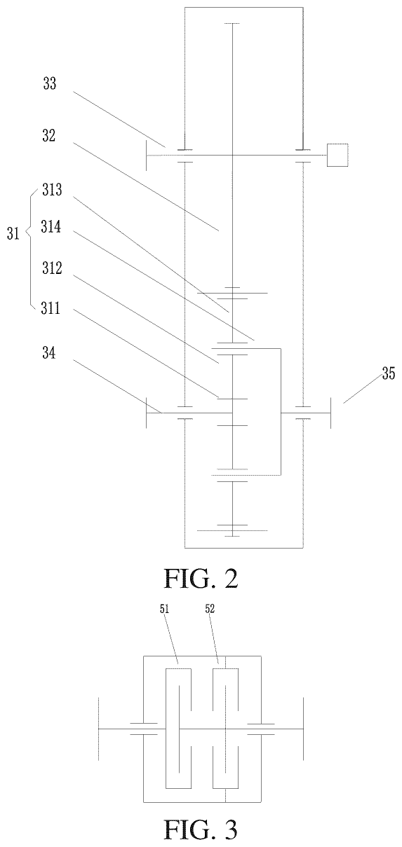

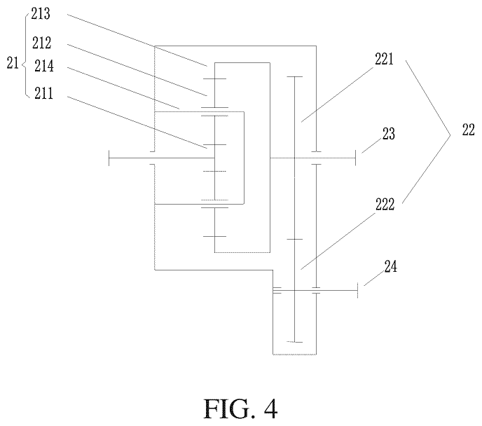

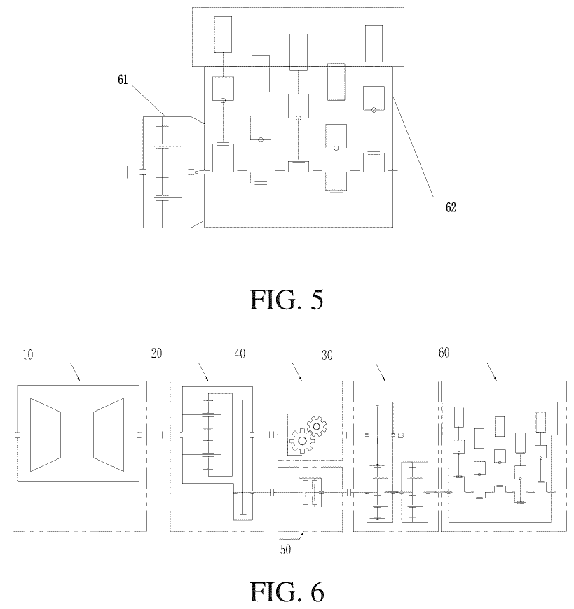

As shown in FIG. 1 to FIG. 5, the embodiments of this application provide a power transmission system. The power transmission system includes an engine 10, a deceleration mechanism 20, and a speed adjustment mechanism 30. The engine 10 is drivingly connected to the deceleration mechanism 20. The deceleration mechanism 20 includes a first power output portion and a second power output portion. The speed adjustment mechanism 30 includes a first power input portion, a second power input portion, and a third power output portion. The first power input portion is selectively connected to or disconnected from the first power output portion, the second power input portion is selectively connected to or disconnected from the second power output portion, and the third power output portion is drivingly connected to a to-be-driven structure 60. The power transmission system has a first diverged state, a second diverged state, and a converged state. When the power transmission system is in the first diverged state, the first power input portion is connected to the first power output portion, and the second power input portion is disconnected from the second power output portion. When the power transmission system is in the second diverged state, the first power input portion is disconnected from the first power output portion, and the second power input portion is connected to the second power output portion. When the power transmission system is in the converged state, the first power input portion is connected to the first power output portion, and the second power input portion is connected to the second power output portion.

Using the power transmission system provided in this embodiment, the first power input portion is selectively connected to or disconnected from the first power output portion, and the second power input portion is selectively connected to or disconnected from the second power output portion, so that the power transmission system can be switched to the first diverged state, the second diverged state, or the converged state, thereby facilitating adjusting an output speed of a driving structure according to a specific working requirement of the to-be-driven structure 60, which improves flexibility of speed adjustment of the power transmission system. Therefore, through technical solutions provided in this application, a technical problem of inconvenience in adjusting an output speed of a power transmission system in the related art can be resolved.

In this embodiment, the speed adjustment mechanism 30 includes a gear speed adjustment structure. In this way, the gear speed adjustment structure has a simple structure, stable transmission, and low manufacturing costs.

The deceleration mechanism 20 includes a gear deceleration structure. In this way, the gear deceleration structure has a simple structure, stable transmission, and low manufacturing costs.

In this embodiment, the speed adjustment mechanism 30 includes a first planetary gear structure 31 and a speed adjustment gear 32. The first planetary gear structure 31 includes a first sun gear 311, a plurality of first planet gears 312, and a first ring gear 313, which are sequentially meshed. The first planetary gear structure 31 further includes a first planet gear carrier 314 rotatably arranged. The plurality of first planet gears 312 is all connected to the first planet gear carrier 314, and the speed adjustment gear 32 is meshed with an outer periphery of the first ring gear 313. A first power input shaft 33 is arranged on the speed adjustment gear 32, and the first power input shaft 33 forms the first power input portion. A second power input shaft 34 is arranged on the first sun gear 311, and the second power input shaft 34 forms a second power input portion. A third power output shaft 35 is arranged on the first planet gear carrier 314, and the third power output shaft 35 forms the third power output portion.

Using the power transmission system provided in this embodiment, when the first power output shaft 23 is connected to the first power input shaft 33, and the second power output shaft 24 is disconnected from the second power input shaft 34, the first power input shaft 33 drives the speed adjustment gear 32, the speed adjustment gear 32 drives the first ring gear 313, and the first ring gear 313 drives the first planet gear carrier 314 to output power. In this case, the power transmission system is in the first diverged state. When the second power output shaft 24 is connected to the second power input shaft 34, and the first power output shaft 23 is disconnected from the first power input shaft 33, the second power input shaft 34 drives the sun gear, and the sun gear drives the first planet gears 312, to drive the first planet gear carrier 314 to output power. In this case, the power system is in the second diverged state. When the first power output shaft 23 is connected to the first power input shaft 33, and the second power output shaft 24 is connected to the second power input shaft 34, the speed adjustment gear 32 drives the first ring gear 313 to adjust a speed of the first planet gear carrier 314, and power on the first power output shaft 23 and power on the second power output shaft 24 are finally output through the first planet gear carrier 314. In this case, the power system is in the converged state. In this embodiment, by using the speed adjustment gear 32 driven by the first power input shaft 33 and the first planet gear driven by the second power input shaft 34, the power transmission system performs state adjustment among the first diverged state, the second diverged state, and the converged state, thereby improving flexibility of speed adjustment of the power transmission system.

In this embodiment, the power transmission system further includes a speed change mechanism 40 and a power disconnection mechanism 50. The power disconnection mechanism 50 has a power-connected state and a power-disconnected state. The speed change mechanism 40 is arranged between the first power input portion and the first power output portion, and the power disconnection mechanism 50 is arranged between the second power input portion and the second power output portion. Alternatively, the speed change mechanism 40 is arranged between the second power input portion and the second power output portion, and the power disconnection mechanism 50 is arranged between the first power input portion and the first power output portion.

Using the power transmission system provided in this embodiment, positions of the speed change mechanism 40 and the power disconnection mechanism 50 can be adjusted. The speed change mechanism 40 and the power disconnection mechanism 50 can be respectively arranged between the first power input portion and the first power output portion and between the second power input portion and the second power output portion, or can be respectively arranged between the second power input portion and the second power output portion and between the first power input portion and the first power output portion. In an embodiment, flexible speed adjustment can be facilitated by the speed change mechanism 40, and flexible power connection or switching can be facilitated by the power disconnection mechanism 50. In this way, power transmission system not only can perform state adjustment among the first diverged state, the second diverged state, and the converged state, but also can adjust positions of the speed change mechanism 40 and the power disconnection mechanism 50 according to different use requirements, thereby further improving flexibility of speed adjustment of the power transmission system.

In this embodiment, the power disconnection mechanism 50 includes a clutch 51 and a brake 52. When the power disconnection mechanism 50 is in the power-connected state, the clutch 51 is engaged with the first power output portion or the second power output portion, and the brake 52 releases braking. When the power disconnection mechanism 50 is in the power-disconnected state, the clutch 51 is disengaged from the first power output portion or the second power output portion, and the brake 52 performs braking. Using such a structural arrangement, when the clutch 51 is engaged or disengaged, forced braking of the engine can be effectively avoided. Particularly, for a turbine engine, because an air compressor, a combustion chamber, and a compressor turbine of the turbine engine are all operating, hot gases in large amounts are still discharged from an exhaust end of the turbine engine. After coming out of the combustion chamber, the hot gases still pass through the compressor turbine to drive the compressor turbine to rotate, to further drive the air compressor to operate. The hot gases pass through a power turbine to be discharged to the exhaust end. When the hot gases pass through the power turbine forcibly braked, the power turbine is still subject to the high temperature and pressure from combustion gas, resulting in impact on a service life of the power turbine of the turbine engine. However, using the foregoing arrangement, the turbine engine does not need to be forcibly braked. Therefore, the foregoing situation is avoided, and the service life of the power turbine can be effectively prolonged.

In this embodiment, the speed change mechanism 40 is a multi-gear structure, and the speed change mechanism 40 has a multi-gear speed adjustment state and a neutral braking state. When the speed change mechanism 40 is in the multi-gear speed adjustment state, the speed change mechanism 40 is configured to decelerate the first power output portion or the second power output portion. In this way, by switching the speed change mechanism 40 to the multi-gear speed adjustment state or the neutral braking state, multi-gear speed adjustment of the speed change mechanism 40 can be facilitated, or power on two sides of the speed change mechanism 40 is disconnected through the speed change mechanism 40, thereby facilitating state adjustment among the first diverged state, the second diverged state, and the converged state. In addition, positions of the speed change mechanism 40 and the power disconnection mechanism 50 can also be adjusted according to different use requirements, thereby improving flexibility of speed adjustment of the power transmission system.

In this embodiment, the deceleration mechanism 20 includes a second planetary gear structure 21 and a parallel-axis gear structure 22. The second planetary gear structure 21 includes a second sun gear 211, a plurality of second planet gears 212, and a second ring gear 213, which are sequentially meshed. The second planetary gear structure 21 further includes a second planet gear carrier 214 fixedly arranged, where the plurality of second planet gears 212 are all connected to the second planet gear carrier 214. The parallel-axis gear structure 22 includes a first parallel-axis gear 221 and a second parallel-axis gear 222 that are meshed and fitted with each other. The second ring gear 213 is connected to the first parallel-axis gear 221 by a transmission shaft, to drive the first parallel-axis gear 221 to rotate. A first power output shaft 23 is arranged on the first parallel-axis gear 221, the first power output shaft 23 forms the first power output portion. A second power output shaft 24 is arranged on the second parallel-axis gear 222, and the second power output shaft 24 forms the second power output portion.

Using the power transmission system provided in this embodiment, after entering the deceleration mechanism 20, the power of the engine 10 drives the second sun gear 211, the plurality of second planet gears 212, and the second ring gear 213 sequentially to rotate. The second ring gear 213 is connected to the first parallel-axis gear 221 by the transmission shaft, to drive the first parallel-axis gear 221 to rotate. The first parallel-axis gear 221 drives the second parallel-axis gear 222 meshed and fitted with the first parallel-axis gear 221 to rotate, to output the power respectively through the first power output shaft 23 on the first parallel-axis gear 221 and the second power output shaft 24 on the second parallel-axis gear 222. In this way, the power of the engine 10 is diverged into two parts through the second planetary gear structure 21 and the parallel-axis gear structure 22, thereby facilitating performing adjustment on a corresponding diverged/converged state according to a specific working requirement of the to-be-driven structure 60, thereby improving flexibility of speed adjustment of the power transmission system.

In some embodiment, the speed change mechanism 40 is a variable-frequency motor. In this way, it can facilitate changing the frequency of the variable-frequency motor to implement speed adjustment, which facilitates the adjustment. In addition, transmission of the variable-frequency motor is stable, which is convenient to implement stable speed adjustment.

In some embodiment, the to-be-driven structure 60 includes a deceleration module 61 and a plunger pump 62. The third power output portion is drivingly connected to a power input end of the deceleration module 61. A power output end of the deceleration module 61 is drivingly connected to the plunger pump 62 to drive the plunger pump 62 to work. In this way, a power input of the plunger pump 62 is increased through the deceleration module 61, so that working efficiency of the to-be-driven structure is improved. Using such a structural arrangement, the engine 10 may be a single-shaft turbine engine, a double-shaft turbine engine, a triple-shaft turbine engine, a reciprocal engine (e.g., a diesel engine and the like), or an electric motor. In this way, the power source can be adjusted and selected according to different power requirements and use scenarios, thereby improving flexibility of speed adjustment of the power transmission system, and resolving a technical problem in the related art that it is inconvenient to perform adaptive adjustment according to working requirements of the to-be-driven structure 60.

As shown in FIG. 1, Embodiment 1 of this application provides a power transmission system. The power transmission system includes a speed change mechanism 40 arranged between a first power input portion and a first power output portion and a power disconnection mechanism 50 arranged between a second power input portion and a second power output portion.

In this embodiment, when the power transmission system is in a first diverged state, the speed change mechanism 40 is in a multi-gear speed adjustment state, to decelerate the first power output portion, the power disconnection mechanism 50 is in a power-disconnected state, a clutch 51 is disengaged from the second power output portion, and a brake 52 performs braking. In this case, power of an engine 10 is output from a first power output shaft 23 through a deceleration mechanism 20 and output to the first power input portion of a speed adjustment mechanism 30 through the speed change mechanism 40, then drives a speed adjustment gear 32 through a first power input shaft 33, and drives a first ring gear 313 through the speed adjustment gear 32, to drive a first planet gear carrier 314, so that the power is output through a third power output shaft 35 arranged on the first planet gear carrier 314, to finally drive a to-be-driven structure 60 to work.

In this embodiment, when the power transmission system is in a second diverged state, the speed change mechanism 40 is in a neutral braking state, the power disconnection mechanism 50 is in a power-connected state, the clutch 51 is engaged with the second power output portion, and the brake 52 releases braking. In this case, the power of the engine 10 is output from the second output portion through the deceleration mechanism 20 and output to the second power input portion of the speed adjustment mechanism 30 through the power disconnection mechanism 50, and then drives a first sun gear 311 through a second power input shaft 34. The first sun gear 311 drives first planet gears 312, to drive the first planet gear carrier 314 and output the power through the third power output shaft 35, to finally drive the to-be-driven structure 60 to work.

In this embodiment, when the power transmission system is in a converged state, the clutch 51 is engaged with the second power output portion, and the brake 52 releases braking. In this case, the power of the engine 10 is output from the second output portion through the deceleration mechanism 20 and output to the second power input portion of the speed adjustment mechanism 30 through the power disconnection mechanism 50, drives the first sun gear 311 through the second power input shaft 34 to rotate, and drives the first planet gears 312 through the first sun gear 311, to drive the first planet gear carrier 314 to move and output the power through the third power output shaft 35. At the same time, the speed change mechanism 40 is in the multi-gear speed adjustment state, to decelerate the first power output portion. The power of an engine 10 is output from the first power output shaft 23 through the deceleration mechanism 20 and output to the first power input portion of the speed adjustment mechanism 30 through the speed change mechanism 40, drives the speed adjustment gear 32 through the first power input shaft 33, and drives the first ring gear 313 through the speed adjustment gear 32, to drive the first planet gear carrier 314, thereby performing speed adjustment on the first planet gear carrier 314. In this way, after the power of the engine 10 is diverged to pass through the power disconnection mechanism 50 and the speed change mechanism 40 respectively, convergence is implemented through the first sun gear 311 and the speed adjustment gear 32 of the speed adjustment mechanism 30, and the to-be-driven structure 60 is finally driven to work.

As shown in FIG. 6, Embodiment 2 of this application provides a power transmission system. The power transmission system in this embodiment differs from the power transmission system provided in Embodiment 1 in that: The to-be-driven structure 60 includes a plunger pump 62, and the speed adjustment mechanism 30 further includes a deceleration module 61, that is, the deceleration module 61 is a part of the speed adjustment mechanism 30 rather than as part of the pump assembly.

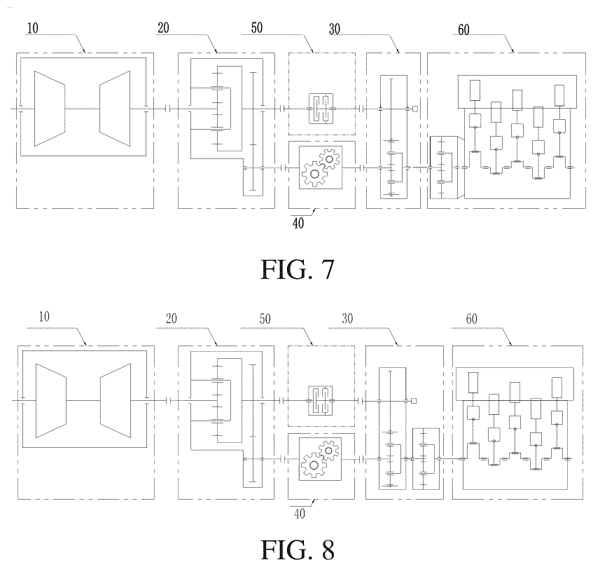

As shown in FIG. 7, in Embodiment 3 of this application, the power disconnection mechanism 50 is arranged between the first power input portion and the first power output portion, and the speed change mechanism 40 is arranged between the second power input portion and the second power output portion.

In this embodiment, when the power transmission system is in the first diverged state, the speed change mechanism 40 is in the neutral braking state, the power disconnection mechanism 50 is in the power-connected state, the clutch 51 is engaged with the first power output portion, the brake 52 releases braking. In this case, the power of the engine 10 is output from the first power output portion through the deceleration mechanism 20 and output to the first power input portion of the speed adjustment mechanism 30 through the power disconnection mechanism 50. In this case, the power of the engine 10 is output from the first power output portion through the power disconnection mechanism 50, and output to the first power input portion of the speed adjustment mechanism 30 through the power disconnection mechanism 50. The first power input shaft 33 drives the speed adjustment gear 32, and the speed adjustment gear 32 drives the first ring gear 313, to drive the first planet gear carrier 314, so that the power is output through the third power output shaft 35 arranged on the first planet gear carrier 314, to finally drive the to-be-driven structure 60 to work.

In this embodiment, when the power transmission system is in the second diverged state, the speed change mechanism 40 is in the multi-gear speed adjustment state, to decelerate the second power output portion, the power disconnection mechanism 50 is in the power-disconnected state, the clutch 51 is disengaged from the first power output portion, and the brake 52 performs braking. In this case, the power of the engine 10 is output from the second output portion through the deceleration mechanism 20 and output to the second power input portion of the speed adjustment mechanism 30 through the speed change mechanism 40, and then drives the first sun gear 311 through the second power input shaft 34. The first sun gear 311 drives the first planet gears 312, to drive the first planet gear carrier 314 and output the power through the third power output shaft 35, to finally drive the to-be-driven structure 60 to work.

In this embodiment, when the power transmission system is in the converged state, the clutch 51 is engaged with the first power output portion, and the brake 52 releases braking. In this case, the power of the engine 10 is output from the first power output portion through the deceleration mechanism 20 and output to the first power input portion of the speed adjustment mechanism 30 through the power disconnection mechanism 50. In this case, the power of the engine 10 is output from the first power output portion through the power disconnection mechanism 50, and output to the first power input portion of the speed adjustment mechanism 30 through the power disconnection mechanism 50. The first power input shaft 33 drives the speed adjustment gear 32, and the speed adjustment gear 32 drives the first ring gear 313, to perform speed adjustment on the first planet gear carrier 314. At the same time, the speed change mechanism 40 is in the multi-gear speed adjustment state, to decelerate the second power output portion. The power of the engine 10 is output from the second output portion through the deceleration mechanism 20 and output to the second power input portion of the speed adjustment mechanism 30 through the speed change mechanism 40, and then drives the first sun gear 311 through the second power input shaft 34. The first sun gear 311 drives the first planet gears 312, to drive the first planet gear carrier 314 and output the power through the third power output shaft 35. In this way, after the power of the engine 10 is diverged to pass through the power disconnection mechanism 50 and the speed change mechanism 40 respectively, convergence is implemented through the first sun gear 311 and the speed adjustment gear 32 of the speed adjustment mechanism 30, and the to-be-driven structure 60 is finally driven to work.

In an embodiment, a working principle of the speed adjustment mechanism 30 is as follows: Power from the upstream is input from the second power input shaft, to drive the first sun gear 311 to rotate. The first sun gear 311 drives the first planet gears 312 to rotate, to further drive the first planet gear carrier 314 to rotate. The first planet gear carrier 314 drives the third power output shaft 35 to rotate. In addition, the first ring gear 313 is driven by the speed adjustment gear 32. A single-row planetary gear row formula is based on: nₛᵤₙ+αnₐₙₙᵤₗᵤₛ−(1+α)n_{carrier}=0, where nₛᵤₙ is a rotation speed of the first sun gear 311, nₐₙₙᵤₗᵤₛ is a rotation speed of the first ring gear 313, n_{carrier} is a rotation speed of the first planet gear carrier 314, a is a ratio of a quantity zₐₙₙᵤₗᵤₛ of teeth of the first ring gear 313 to a quantity zₛᵤₙ of teeth of the first sun gear 311, that is, α=zₐₙₙᵤₗᵤₛ/zₛᵤₙ, and α>1. Therefore, the rotation speed n_{carrier} of the first planet gear carrier 314 is (nₛᵤₙ+αnₐₙₙᵤₗᵤₛ)/(1+α). Based on the foregoing formula, when the first ring gear 313 does not have a rotation speed, that is, when the rotation speed of the first ring gear 313 is 0, the rotation speed n_{carrier} of the first planet gear carrier 314 is nₛᵤₙ/(1+α). In other words, the rotation speed of the third power output shaft 35 depends on only a speed ratio α between the first ring gear 313 and the first sun gear 311.

When the first power input shaft 33 rotates, the first power input shaft 33 drives the speed adjustment gear 32 to rotate, and the speed adjustment gear 32 drives the first ring gear 313 to rotate. In this case, the rotation speed n_{carrier} of the first planet gear carrier 314 is (nₛᵤₙ+αnₐₙₙᵤₗᵤₛ)/(1+α). In this way, when a rotation speed of the first power input shaft 33 is the highest, that is, a rotation speed of the corresponding first ring gear 313 is the highest, the rotation speed of the first planet gear carrier 314, that is, a rotation speed of the third power output shaft 35, reaches a maximum.

As shown in FIG. 8, Embodiment 4 of this application provides a power transmission system. The power transmission system in this embodiment differs from the power transmission system provided in Embodiment 3 in that: The to-be-driven structure 60 includes a plunger pump 62, and the speed adjustment mechanism 30 further includes a deceleration module 61, that is, the deceleration module 61 is a part of the speed adjustment mechanism 30.

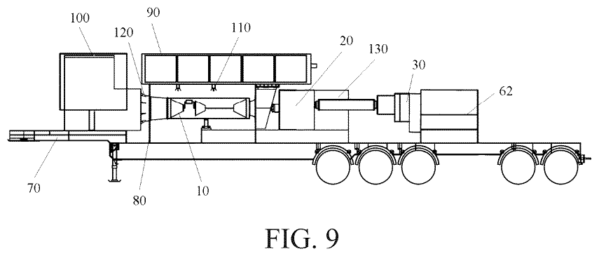

As shown in FIG. 9, Embodiment 5 of the present application provides turbine fracturing device. The turbine fracturing device includes the power transmission system provided in the foregoing embodiments and a carrier 70. The power transmission system is mounted on the carrier 70.

In an embodiment, the turbine fracturing device further includes a muffling compartment 80. The muffling compartment 80 is arranged on the carrier 70. The muffling compartment 80 includes a muffling cavity. The engine 10 of the power transmission system is arranged in the muffling cavity. Using such a structural arrangement, noise generated by the engine 10 can be reduced conveniently.

In this embodiment, the turbine fracturing device further includes an air inlet compartment body 90. The air inlet compartment body 90 is arranged on the carrier 70. An inlet of the air inlet compartment body 90 is configured to admit air. An outlet of the air inlet compartment body 90 is in communication with an air inlet of the engine 10. In this way, it is convenient to perform an air inlet operation on the muffling compartment 80. In an embodiment, the air inlet compartment body 90 is located above the muffling compartment 80.

In an embodiment, the turbine fracturing device in this embodiment further includes a muffler 100. The muffler 100 is arranged on the carrier 70. A muffler inlet of the muffler 100 is in communication with an exhaust port of the engine 10, to muffle a gas exhausted through the exhaust port. In this way, it is convenient to provide an external gas to the muffler 100.

In an embodiment, the turbine fracturing device further includes a diffusion tube 120. The diffusion tube 120 is arranged between the muffler inlet of the muffler 100 and the exhaust port, to diffuse the gas through the diffusion tube 120, thereby better reducing noise.

In this embodiment, the turbine fracturing device further includes a fire-fighting system 110. At least part of the fire-fighting system 110 is arranged in the muffling cavity. Using such a structural arrangement, fire-fighting safety of the structure in the muffling cavity can be conveniently ensured. In an embodiment, the fire-fighting system 110 includes a sprinkler head, a sensing component, and a pipeline. The sprinkler head and the sensing component are arranged in the muffling cavity. The pipeline is connected to the sprinkler head. A part of the pipeline is located inside the muffling cavity, and the other part of the pipeline is located outside the muffling cavity.

In an embodiment, the turbine fracturing device further includes an auxiliary power system. The auxiliary power system is arranged on the carrier 70. The engine of the power transmission system drives the auxiliary power system to operate. The auxiliary power system includes at least one of a load component lubrication driving component, a lubricant cooling driving component, a ventilation driving component arranged in the muffling cavity, an air path system driving component, a control system driving component, or an air compressor. Using such a structural arrangement, the auxiliary power system can be conveniently driven to operate, thereby ensuring operation of other structures while fracturing is performed.

In an embodiment, the auxiliary power system takes off power from the engine. A power take-off position of the auxiliary power system may be on a gearbox 130, on a high-speed deceleration box, or at a power take-off port.

In an embodiment, the load component lubrication driving component is configured to provide, to the load component, power for driving a lubricating oil. The load component lubrication driving component includes a fracturing plunger pump lubrication system, a turbine lubrication system, a high-speed deceleration box lubrication system, a gearbox lubrication system, a clutch brake lubrication system, and the like. A function of a lubricant cooling driving component is that: During lubrication, a lubricant flows inside the device during, to carry away heat generated inside a load component. The lubricant needs to be recycled. Therefore, the lubricant cooling driving component needs to cool the part of lubricant. An air path system driving component supplies air to a component that needs to use compressed air in the device. For example, during operation, a shut-off valve on a fuel gas pipe and a bleed valve on the turbine both need to be powered by compressed air to open, and dust inside an inertial separator also needs to be purged by compressed air. A control system driving component include a battery system, a power generator, and a hydraulic motor. Because a control system needs to provide 24 V electricity, the battery system is configured. Electricity is continuously supplied to the battery system through a 24 V power generator. A component driving the power generator can be driven by the hydraulic motor or the like. The air compressor can provide compressed air at a specific pressure to an air path system.

In an embodiment, the turbine fracturing device in this embodiment further includes an air inlet volute. The air inlet volute can provide a channel for the engine 10 to admit air. That is, after passing through an inertial separator-filter-muffler of an air inlet apparatus, the air needs to pass through the channel of the air inlet volute due to a spatial arrangement, and finally, enters the air inlet of the engine 10. In an embodiment, the engine 10 is a turbine.

In an embodiment, the ventilation driving component is configured to drive an air inlet process or an air outlet process of the muffling cavity.

In an embodiment, the carrier is a semi-trailer structure, to facilitate connection to a vehicle body and facilitate position transfer.

It can be learned from the foregoing descriptions that, the foregoing embodiments of this application implement the following technical features: the first power input portion is selectively connected to or disconnected from the first power output portion, and the second power input portion is selectively connected to or disconnected from the second power output portion, so that the power transmission system can be switched to the first diverged state, the second diverged state, or the converged state, to satisfy speed adjustment requirements using different states. In the converged state, the speed of the third power output shaft 35 is adjusted through the first ring gear 313, thereby improving flexibility of speed adjustment of the power transmission system. By charging a connecting member between the first power input portion and the first power output portion and a connecting member between the second power input portion and second power output portion, an output mode of power can also be changed, thereby satisfying different speed adjustment requirements using different structures. In conclusion, the power transmission system provided in this application can perform corresponding state adjustment according to a specific working requirement of the to-be-driven structure, thereby greatly improving flexibility of speed adjustment of the power transmission system.

It should be noted that terms used herein are only for the purpose of describing specific implementations and are not intended to limit the exemplary implementations of this application. As used herein, the singular form is intended to include the plural form, unless the context clearly indicates otherwise. In addition, it should be further understood that terms “include” and/or “comprise” used in this specification indicate that there are features, steps, operations, devices, assemblies, and/or combinations thereof.

Unless otherwise specified, the relative deployment, the numerical expression, and values of the components and steps described in the embodiments do not limit the scope of this application. In addition, it should be understood that, for ease of description, sizes of parts shown in the accompanying drawings are not drawn according to an actual proportional relationship. Technologies, methods, and devices known to a person of ordinary skill in the art may not be discussed in detail, but in proper circumstances, the technologies, methods, and devices shall be regarded as a part of the specification. In all examples that are shown and discussed herein, any specific value should be interpreted only as an example and not as a constraint. Therefore, other examples of the exemplary embodiments may have different values. It should be noted that: similar reference signs or letters in the accompanying drawings indicate similar items. Therefore, once an item is defined in one accompanying drawing, the item does not need to be further discussed in the subsequent accompanying drawings.

In the description of this application, it should be understood that orientation or position relationships indicated by orientation terms, such as “front, rear, upper, lower, left, and right”, “transverse, vertical, perpendicular, and horizontal”, and “top, and bottom”, are based on orientation or position relationships shown in the accompanying drawings, and are used only for ease and brevity of illustration and description of this application. Unless otherwise stated, the orientation terms do not indicate or imply that the mentioned apparatus or element needs to have a particular orientation or needs to be constructed and operated in a particular orientation. Therefore, such terms should not be construed as limiting of the protection scope of this application. The orientation terms “inside and outside” refer to the inside and outside of outlines of the components.

For ease of description, space-related terms, such as “over”, “above”, “on the upper surface”, and “upper”, may be used herein for describing a spatial location relationship between one device or feature and another device or feature as shown in the figures. It should be understood that, the space-related terms are intended to encompass different orientations of the device in use or operation other than the orientations described in the figures. For example, if the devices in the accompanying drawings are reversed, the devices that are described as “above another device or structure” or “on another device or structure” are defined as “below another device or structure” or “under another device or structure”. Therefore, the exemplary term “above” may include two orientations: “above” and “below”. The device may alternatively be positioned in other different manners (rotating by 90 degrees or being located at other orientations), and space-related descriptions used herein are explained accordingly.

In addition, it should be noted that the terms such as “first”, and “second” are used to define parts only to make it easier to distinguish the parts. Unless otherwise stated, the terms have no special meanings, and therefore cannot be construed as limiting the protection scope of this application

The foregoing descriptions are merely preferred embodiments of this disclosure, but are not intended to limit this application. For a person skilled in the art, this application may have various modifications and changes. Any modification, equivalent replacement, or improvement made without departing from the spirit and principle of this application shall fall within the protection scope of this application.

What is claimed is:

1. A power transmission system, comprising:
an engine;
a deceleration mechanism, comprising a first power output portion and a second power output portion, wherein the engine is drivingly connected to the deceleration mechanism; and
a speed adjustment mechanism comprising a first power input portion, a second power input portion, and a third power output portion, wherein the first power input portion is selectively connected to or disconnected from the first power output portion, the second power input portion is selectively connected to or disconnected from the second power output portion, and the third power output portion is drivingly connected to a to-be-driven structure,
wherein:
the power transmission system is configured to operate in one of a first diverged state, a second diverged state, and a converged state;
when the power transmission system is in the first diverged state, the first power input portion is connected to the first power output portion, and the second power input portion is disconnected from the second power output portion;
when the power transmission system is in the second diverged state, the first power input portion is disconnected from the first power output portion, and the second power input portion is connected to the second power output portion; and
when the power transmission system is in the converged state, the first power input portion is connected to the first power output portion, and the second power input portion is connected to the second power output portion.

2. The power transmission system according to claim 1, wherein:
the speed adjustment mechanism comprises a gear speed adjustment structure.

3. The power transmission system according to claim 1, wherein:
the deceleration mechanism comprises a gear deceleration structure.

4. The power transmission system according to claim 1, wherein the speed adjustment mechanism comprises:
a first planetary gear structure, comprising a first sun gear, a plurality of first planet gears, and a first ring gear, which are sequentially meshed, and further comprising a first planet gear carrier rotatably arranged, wherein the plurality of first planet gears are all connected to the first ring gear;
a speed adjustment gear, wherein the speed adjustment gear is meshed with an outer periphery of the first ring gear;
a first power input shaft arranged on the speed adjustment gear and forming the first power input portion;
a second power input shaft arranged on the first sun gear and forming the second power input portion; and
a third power output shaft arranged on the first ring gear and forming the third power output portion.

5. The power transmission system according to claim 1, further comprising:
a speed change mechanism; and
a power disconnection mechanism configured to operate in one of a power-connected state and a power-disconnected state,
wherein:
the speed change mechanism is arranged between the first power input portion and the first power output portion, and the power disconnection mechanism is arranged between the second power input portion and the second power output portion; or
the speed change mechanism is arranged between the second power input portion and the second power output portion, and the power disconnection mechanism is arranged between the first power input portion and the first power output portion.

6. The power transmission system according to claim 5, wherein:
the power disconnection mechanism comprises a clutch and a brake;
when the power disconnection mechanism is in the power-connected state, the clutch is engaged with the first power output portion or the second power output portion, and the brake releases braking; and
when the power disconnection mechanism is in the power-disconnected state, the clutch is disengaged from the first power output portion or the second power output portion, and the brake performs braking.

7. The power transmission system according to claim 5, wherein:
the speed change mechanism is a multi-gear structure and has a multi-gear speed adjustment state and a neutral braking state, and
when the speed change mechanism is in the multi-gear speed adjustment state, the speed change mechanism is configured to decelerate the first power output portion or the second power output portion.

8. The power transmission system according to claim 1, wherein the deceleration mechanism comprises:
a second planetary gear structure, comprising a second sun gear, a plurality of second planet gears, and a second ring gear, which are sequentially meshed, and further comprising a second planet gear carrier fixedly arranged, wherein the plurality of second planet gears is all connected to the second planet gear carrier;
a parallel-axis gear structure, comprising a first parallel-axis gear and a second parallel-axis gear that are meshed and fitted with each other;
a first power output shaft, wherein the second ring gear is connected to the first parallel-axis gear by the first power output shaft to drive the first parallel-axis gear to rotate, and the first power output shaft forms the first power output portion; and
a second power output shaft, wherein the second power output shaft is arranged on the second parallel-axis gear and forms the second power output portion.

9. The power transmission system according to claim 5, wherein the speed change mechanism comprises a variable-frequency motor.

10. The power transmission system according to claim 1, wherein the to-be-driven structure comprises:
a deceleration module, wherein the third power output portion is drivingly connected to a power input end of the deceleration module; and
a plunger pump, wherein a power output end of the deceleration module is drivingly connected to the plunger pump to drive the plunger pump to operate.

11. The power transmission system according to claim 1, wherein the engine comprises one of a single-shaft turbine engine, a double-shaft turbine engine, a triple-shaft turbine engine, a reciprocal engine, or an electric motor.

12. A turbine fracturing device, comprising:
the power transmission system according to claim 1; and
a carrier, wherein the power transmission system is mounted on the carrier.

13. The turbine fracturing device according to claim 12, further comprising:
a muffling compartment, arranged on the carrier and comprising a muffling cavity, wherein the engine of the power transmission system is arranged in the muffling cavity.

14. The turbine fracturing device according to claim 13, further comprising:
an air inlet compartment body, arranged on the carrier, wherein an inlet of the air inlet compartment body is configured to admit air, and an outlet of the air inlet compartment body is in communication with an air inlet of the engine.

15. The turbine fracturing device according to claim 13, further comprising:
a muffler, arranged on the carrier, wherein a muffler inlet of the muffler is in communication with an exhaust port of the engine, and wherein the muffler is configured to muffle a gas discharged through the exhaust port of the engine.

16. The turbine fracturing device according to claim 13, further comprising:
a fire-fighting system, wherein at least a part of the fire-fighting system is arranged in the muffling cavity.

17. The turbine fracturing device according to claim 13, further comprising an auxiliary power system arranged on the carrier and comprising at least one of:
a load component lubrication driving component;
a lubricant cooling driving component;
a ventilation driving component arranged in the muffling cavity;
an air path system driving component;
a control system driving component; or
an air compressor,
wherein the engine of the power transmission system is configured to drive the auxiliary power system to operate.

18. The turbine fracturing device according to claim 12, wherein the carrier is a semi-trailer structure.

19. The turbine fracturing device according to claim 12, wherein the engine of the power transmission system comprises a single-shaft turbine engine, a double-shaft turbine engine, a triple-shaft turbine engine, a reciprocal engine, or an electric motor.
